(19) United States
(12) Patent Application Publication
(10) Pub. No.: US 2005/0056105 A1
(43) Pub. Date: Mar. 17, 2005

(54) Method and apparatus for inspection of reactor head components

(76) Inventors: Bradley S. Delacroix, Ontario, NY (US); Matthew R. Jewett, Ontario, NY (US); Mick D. Mayfield, Byon, IL (US); Randall K. Lewis, Fairport, NY (US)

Correspondence Address: Joseph M. Noto;NIXON PEABODY LLP, Clinton Square, P.O. Box 31051, Rochester, NY, 14603-1051, US

(21) Appl. No.: 10/858,404

(22) Filed: Jun. 2, 2004

Related U.S. Application Data
(60) Provisional application No. 60/474,621, filed on Jun. 2, 2003.

(51) Int. Cl. G21C 17/017; G21C 17/003; G01N 27/87; G01N 27/90; G01N 21/88

(52) U.S. Cl. 73/865.8; 376/249; 348/83; 324/220

(57) ABSTRACT

A reactor head inspection system for use in performing a non-destructive inspection of tubular components mounted on an interior surface of a reactor head is disclosed. The inspection system includes a movable carriage assembly including a elevation arm and an inspection device mounted at a distal end of the elevation arm. The inspection device includes a C- or U-shaped collar having an interior surface of sufficient interior dimension to enable positioning of the interior surface of the collar in close proximity of an exterior surface of a tubular component and also includes a magnetic and/or eddy current sensor. A plurality of video cameras and light sources are also provided on a distal surface of the collar such that, when mounted on the elevation arm, the collar can be controllably positioned in close proximity adjacent a tubular component of the reactor head to achieve a 360° view and inspection of a surface of the tubular component.

### BACKGROUND OF THE INVENTION

1. Field of the Invention

The invention relates to a method and apparatus for inspecting the head assembly of a reactor vessel. Particularly, the invention describes a system for performing remote external (visual) and internal (e.g. magnetic field, eddy current) inspection on site of the interior of a head of a reactor vessel during periods of servicing and recharging the reactor vessel. In particular, the method of the invention employs a sensor system which includes an ability to not only locate flaws, i.e. cracks, in the reactor head components, but also includes an ability to predict the formation of flaws by monitoring the magnetic permeability of the reactor head components. A visual inspection device of the invention functions both as a positioning device for precise location of an inspection device and as a 360° evaluation device of the surfaces of a reactor component, e.g., J-weld. Further, the internal inspection device of the invention performs a 360° evaluation of a reactor component. The transport system of the invention includes a remotely controlled carriage which can be moved into position after the reactor head assembly is placed onto a support structure and can be precisely placed for deployment of the internal and external inspection device.

2. Description of Related Art

Conventionally, the internal components of a reactor are inspected by removing the components and placing the components on a support stand which enables remote inspection of the components. See U.S. Pat. No. 5,544,205 in which reactor fuel rod components are removed from the reactor to a support station, and inspected using a remote camera to position a carriage supporting the inspection device. The support station assembly before inspection must undergo a setup operation which includes filling the inspection station with water and positioning a complementary overhead mast structure to cooperate with the inspection device. The inspection device, such as a remote measurement sensor, i.e., a reflected laser light source/photodetector, is coupled with the overhead mast for vertical positioning inside the guide tubes of the reactor. U.S. Pat. No. 4,272,781 teaches a similar inspection device in which a camera for controlling the position of a measurement probe. The positioning camera and probe are each mounted on a movable carriage for movement over a variety of surfaces, preferable smooth curved surfaces. U.S. Pat. Nos. 5,745,387 and 6,282,461 teach other video positioning systems for inspection probes in which the video camera is mounted at the distal end of a manipulator arm.

Visual inspection devices for control rod guide tubes also well known, as shown in U.S. Pat. No. 5,078,955. This system employs an internal inspection device which is positioned within the guide tube and moved to a position for visually inspecting openings in the guide tube. U.S. Pat. Nos. 4,729,423 and 5,604,532 teach other methods and apparatus for visually inspecting the ends of reactor tubes or the inside of a pressurized vessel utilizing a camera mounted on the end of a laterally adjustable boom mounted inside the vessel.

The inspection of the interior of welds on reactor tubes, tube sheets and support plates can be performed utilizing sonic, magnetic and electric field sensors. U.S. Pat. Nos. 6,624,628, 6,526,114, 5,835,547 and 5,710,378 teach the use of such sensor probes to evaluate the interior of reactor components. Additionally, many variations of a movable carriage, such as those described in U.S. Pat. Nos. 5,350,033, 6,672,413 and 4,569,230, are known for positioning inspection probes within reactor vessels.

For reactors, particularly nuclear reactors, it is necessary to perform an inspection of each component of the reactor at regular periodic maintenance intervals. Inspection devices, like those discussed above, have not been developed to inspect the components of the reactor head without requiring the extensive setup procedure. For example, the conventional reactor head can include a plurality of openings having secured therein guide sleeves which are welded in place. The sleeves can receive a rack assembly extending in closely spaced tolerance within the sleeve and a prescribed distance into the reactor. A reliable inspection system is needed for repeatedly evaluating each sleeve component of the reactor head to not only determine that the tolerances of the rack assembly within a sleeve are within an acceptable range, but also to determine the fitness of each component weld, i.e., determine the presence of actual flaws (cracks) in the component and predict the likelihood of flaws occurring by sensing the magnetic permeability of the component. None of the inspection systems of the prior art discussed above provides a robust, versatile inspection device and/or carriage for performing these inspection functions for reactor head components.

While the inspection systems of the prior art above do not solve the need for repeatedly inspecting the components of a reactor head, those systems are also quite complicated, require extensive manufacturing operations and considerable expense. A simpler system is needed for repeatedly, visually inspecting the exterior surfaces of reactor head components and non-destructively inspecting the inside of the same components to determine the presence of flaws and to predict the likely location of the formation of flaws.

### SUMMARY OF THE INVENTION

A primary object of the present invention is to provide an apparatus and method for transporting a sensor assembly to the inside a reactor head and easily, repeatedly positioning a visual inspection and/or non-destructive inspection probe into close proximity along a component of a reactor head for inspection of the component surface and/or the interior of the component, particularly, to determine the presence of flaws and predict the likelihood of the formation of flaws in the component, as well as any loss of tolerances in the component.

This object of the invention is achieved by providing a movable carriage having elevation support elements for positioning the inspection probe and providing a simple probe element which will enable 360° inspection of the exterior and/or interior of the reactor head components.

In one embodiment of the invention, the probe is constructed as an open-ended inspection collar, e.g., C- or U-shaped inspection collar, having embedded video cameras and, a non-destructive inspection device, such as an eddy-current measurement sensor, ultrasonic sensor, magnetic field sensor. In a preferred embodiment, the collar is mounted at the end of an elevator arm supported by a movable carriage and includes a magnetic inspection probe having a magnetic permeability sensor which determines the location of actual flaws in the reactor component, and also enables accurate prediction of the location of the formation of flaws at some later time.

The method of inspection of the invention involves precisely positioning the C- or U-shaped collar in close proximity to a reactor head component utilizing the video cameras, e.g. position adjacent a guide sleeve and rack assembly, such that both a 360° video inspection of the exterior surface and tolerances of the components can be performed employing the video cameras. The video cameras also enable precise positioning of an internal, non-destructive inspection device to enable a 360° non-destructive inspection of the interior of the components to be performed, e.g., an inspection of each weld of the components.

The invention is explained in greater detail below with reference to the embodiments and the accompanying drawings.

### BRIEF DESCRIPTION OF THE DRAWINGS

FIGS. 1A and 1B show a reactor head and components to be inspected at an inspection station;

FIG. 2 shows, in an exploded view of a portion A of FIG. 1B, a detailed representation of a reactor penetration component, and a rack assembly within a thermal guide sleeve of the reactor head;

FIGS. 3A, 3B and 3C show an inspection device of the invention;

FIGS. 4A-4C show the U- or C-shaped inspection device of FIG. 3B positioned adjacent a rack assembly for inspection of a penetration component of a reactor head;

FIGS. 5A and 5B show a movable carriage of the invention, in the collapsed and extended state, respectively, employing a elevation boom having an inspection device positioned on the distal end thereof;

FIGS. 6A, 6B and 6C show a preferred magnetic field sensing and eddy current sensing probe to be mounted on the inspection device;

FIGS. 7A and 7B show another embodiment of the inspection device of the invention for inspecting a J-weld, as well as the reactor interior surfaces and exterior surfaces of a reactor penetration component; and

FIGS. 8A-8C show isometric and bottom views of the blade head of FIGS. 7A and 7B and the sensing probe of FIGS. 6A-6C mounted thereon.

### DETAILED DESCRIPTION OF THE INVENTION

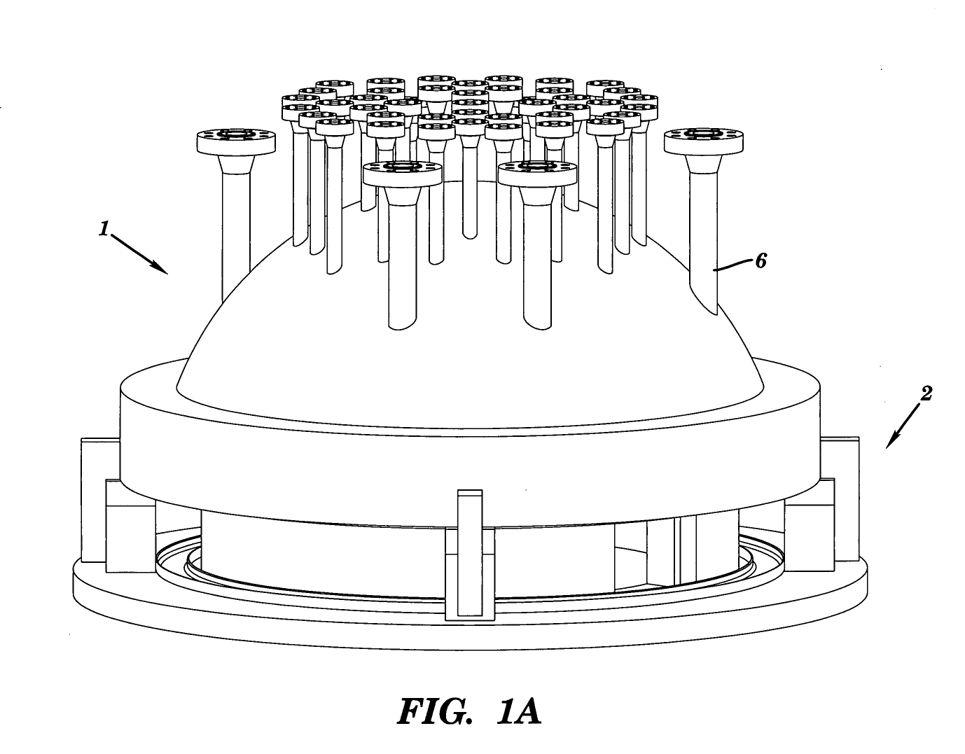

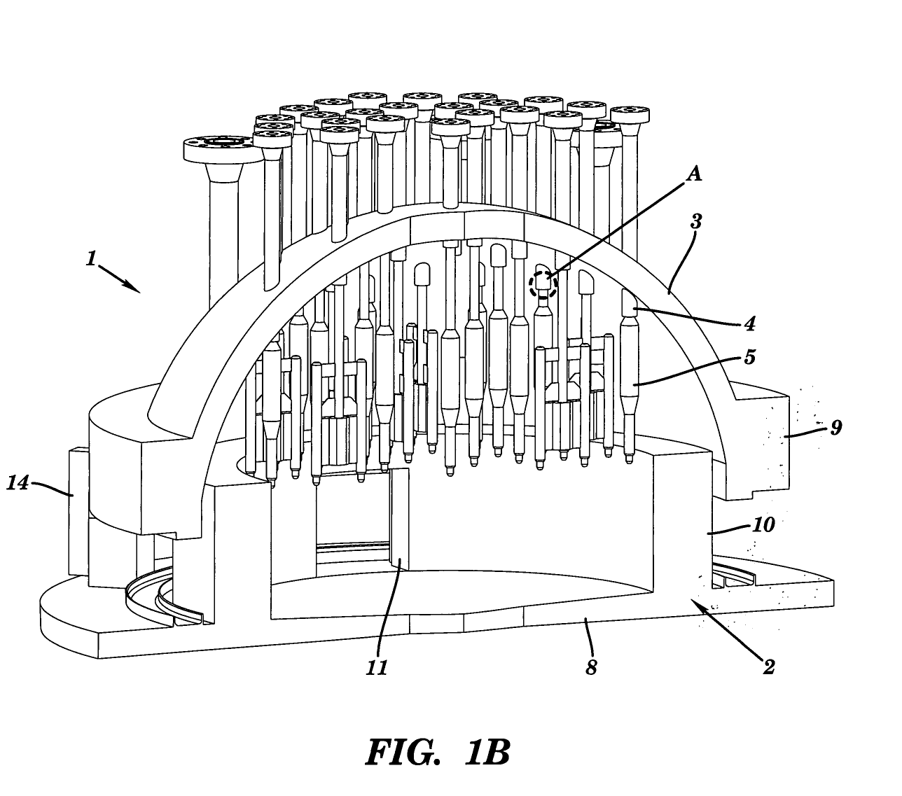

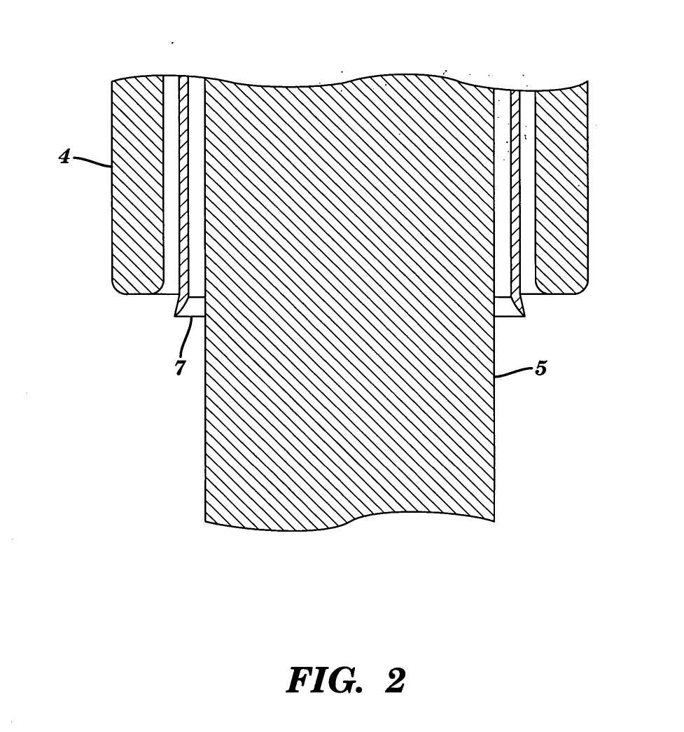

The reactor head 1 of FIG. 1A is shown to be resting on an inspection station 2; while FIG. 1B illustrates a cross sectional view of both the reactor head and the inspection station 2. Specifically, the reactor head 1 includes a shell 3 through which penetration components 4 extend and each penetration component is welded to the shell 3 by a conventional J-weld. Each penetration component 3 has a rack assembly 5 extending concentrically therein; the details of which are shown in FIG. 2. Additional in-core penetration components 6 are shown distributed around the penetration components 4 and, like the penetration components will be inspected by the inspection system of the invention. FIG. 2 illustrates in an exploded view a penetration component 4 and the rack assembly 5 concentrically assembled. Additionally, between the penetration component 4 and rack assembly 5 is positioned a thermal guide sleeve 7 which insulates the penetration component from the temperatures of the rack assembly.

The support stand 8 of the inspection station 2 includes support columns 14, e.g., four, upon which the rim 9 of the reactor head rests. The support stand 8 further includes a shield wall 10 having an access port 11 through which the moveable carriage 12, containing the inspection probe 13, moves in order to be positioned for inspection of the penetration components. Prior to the actual inspection, the reactor head is removed from the reactor vessel and placed onto the support columns. Thereafter, the carriage 12 can be moved beneath the reactor head 1 and the inspection process begun.

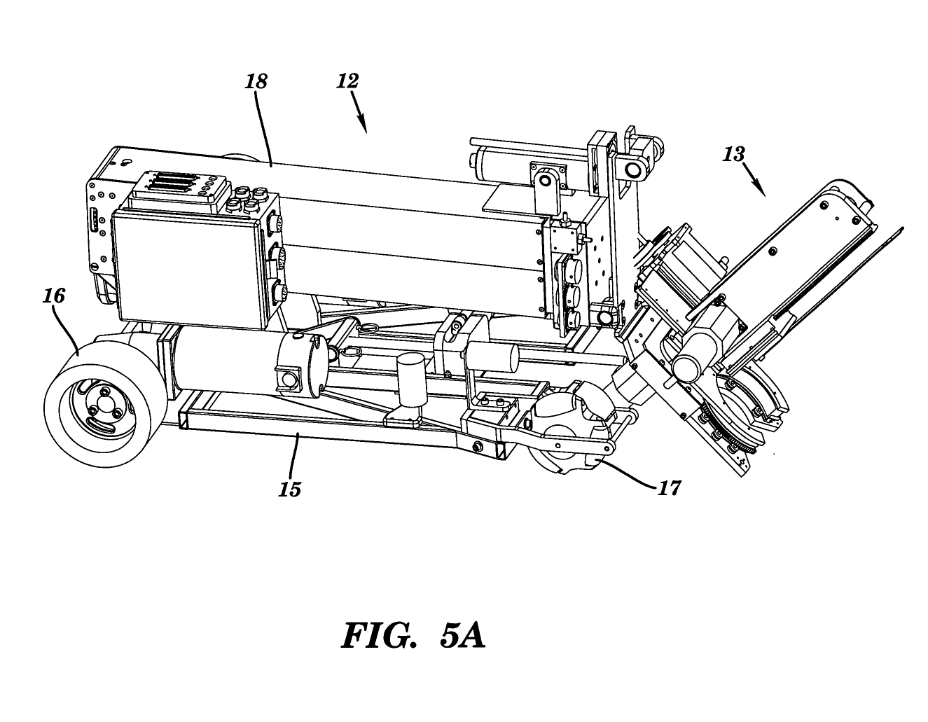

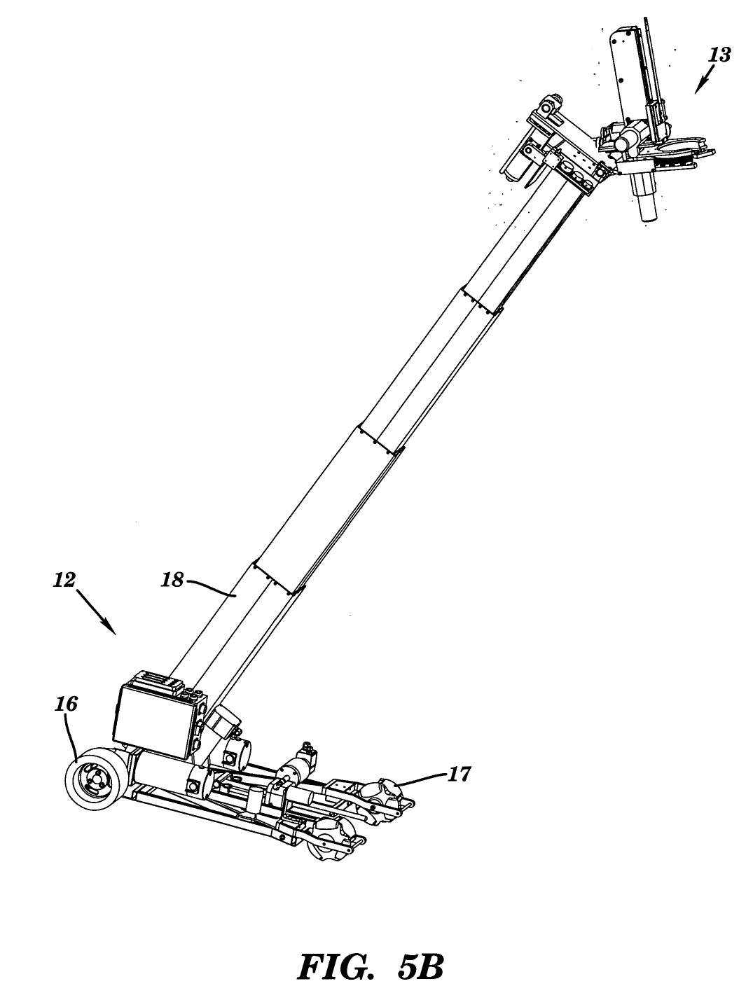

FIGS. 5A and 5B illustrate one embodiment of the moveable carriage 12 of the invention. Specifically, the moveable carriage 12 includes frame 15, having two drive wheels 16 and two omni-directional wheels 17 which cooperate to move the carriage to a general location beneath a particular penetration component. The inspection probe 13 is mounted for rotational, X-axis, Y-axis and Z-axis movement on the end of an extendable boom 18, shown in FIG. 5A in its collapsed state and in FIG. 5B in its extendable state. Any conventional extension elements can be used to extend and collapse the boon 18, e.g., a lead screw and motor assembly, a hydraulic piston-shaft arrangement or gas sleeve arrangement.

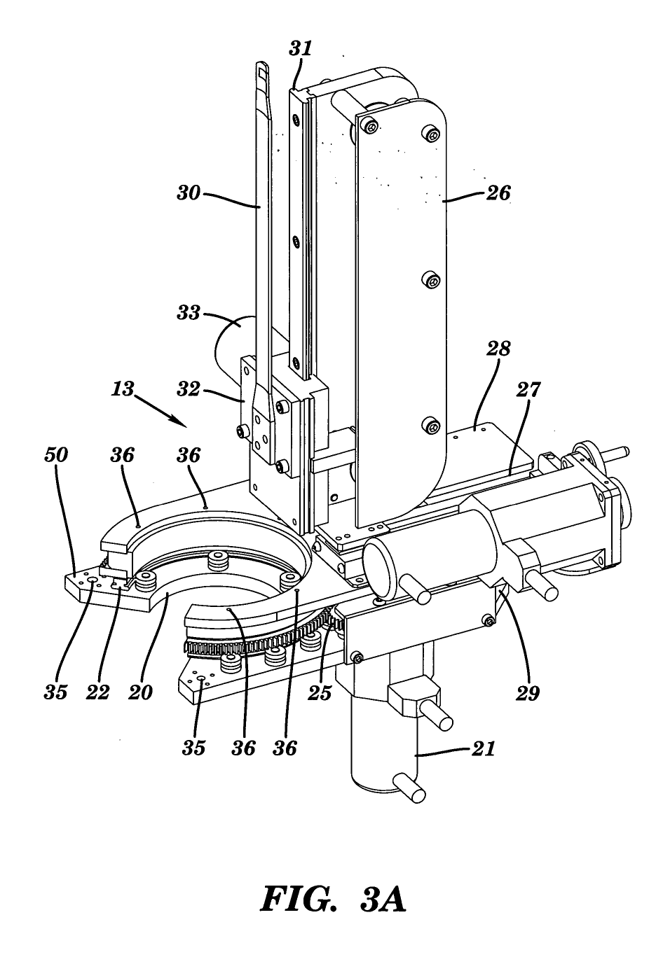

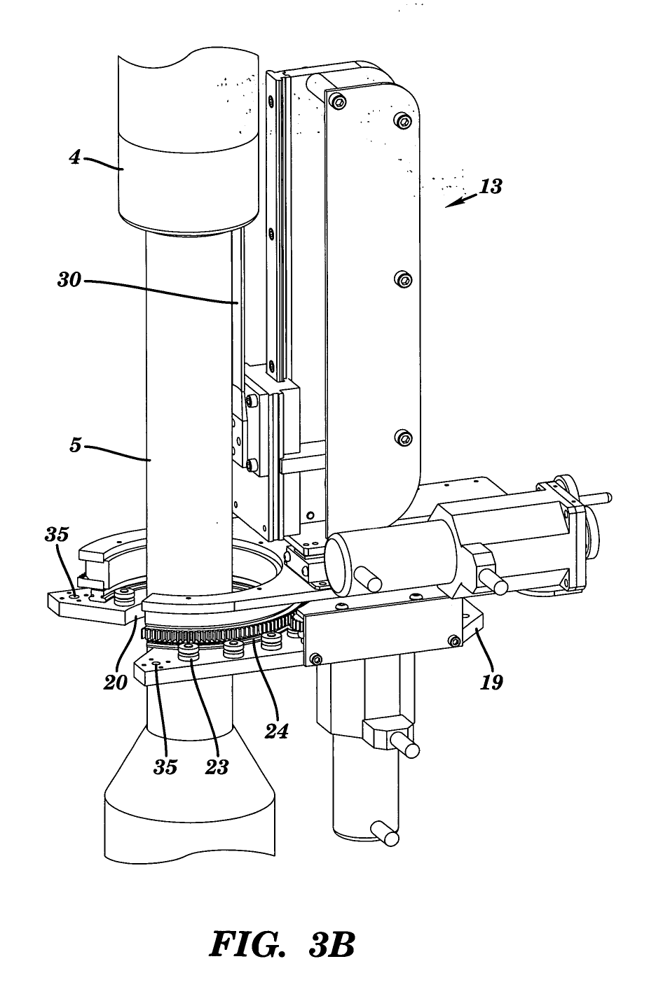

The details of the inspection probe 13 of one embodiment of the invention are illustrated in FIGS. 3A and 3B. The sensing probe 13 is mounted on a support base 19 which enables mounting of the inspection probe 13 to the boom 18 and enables rotational movement of the probe 13 around the center axis of the rack assembly. The support base 19 is fixed on the boom at one end thereof and at the other end includes a U- or C-shaped collar 20 to be positioned adjacent a rack assembly 5 as shown in FIG. 3B. The rotational movement of the sensing probe around the center axis of the probe is effected by the use of a wheel assembly 23 on the support base 19 and track 22 and wheel gear assembly 24 on the inspection probe 13. The wheel gear assembly 24 is drive by motor gears 25 (only one shown) mounted on the support base 19 which are positioned in spaced apart relationship on the inspection probe such that at least one motor gear 25 is always engaged with the wheel gear assembly. In a similar manner, the opening between the ends of the wheel gear 25 also forms a U- or C-shaped collar and the dimension of the opening is selected such that a portion of the track 22 will always be in engagement with at least one of the wheels 23 on the support base 19. Such an arrangement will permit the inspection probe 13 to move in a 360° arc around the center of axis of the rack assembly 5.

The X-axis and Y-axis movement is effected by movement of the probe boom 26 along a slide 27 on the probe base 28. Note that the track 22 and wheel gear assembly 24 are affixed to the probe base 28 to enable the 360° arc movement of the inspection probe 13. The motor 29, mounted on the probe base 28, moves the probe boom 26 via conventional gearing (not shown).

The Z-axis (vertical) movement of the sensing probe blade 30 on the probe boom 26 is accomplished by means cooperation of a slide 31 mounted on the probe boom 26 and probe blade support 32. A motor 33, mounted on the probe boom 26, drives the probe blade support 32 on the slide again via conventional gearing (not shown).

FIGS. 3A and 3B also illustrate the placement of the video cameras 35 and light sources 50 on the support base 19 adjacent the collar 20 which are used to effect remote control positioning of the extendable boon 18 as well as precise positioning of the collar 20 of the inspection probe 13 directly adjacent the rack assembly (FIG. 3B). Alternatively, or in addition to cameras 35, video cameras 36 can be mounted at the U- or C-shaped distal end of the probe base 28 which would also enable remotely controlled, precise location of the inspection probe 13 and video inspection of the gap 34 between the rack assembly 5 and the penetration component 4.

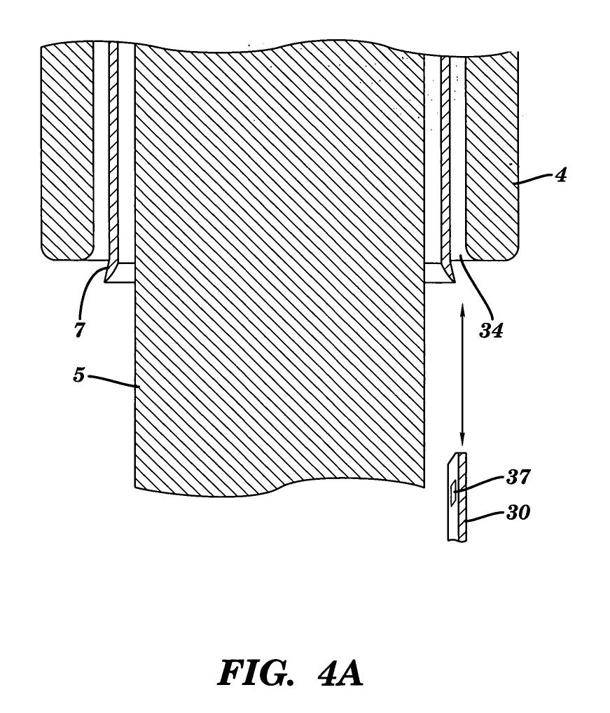

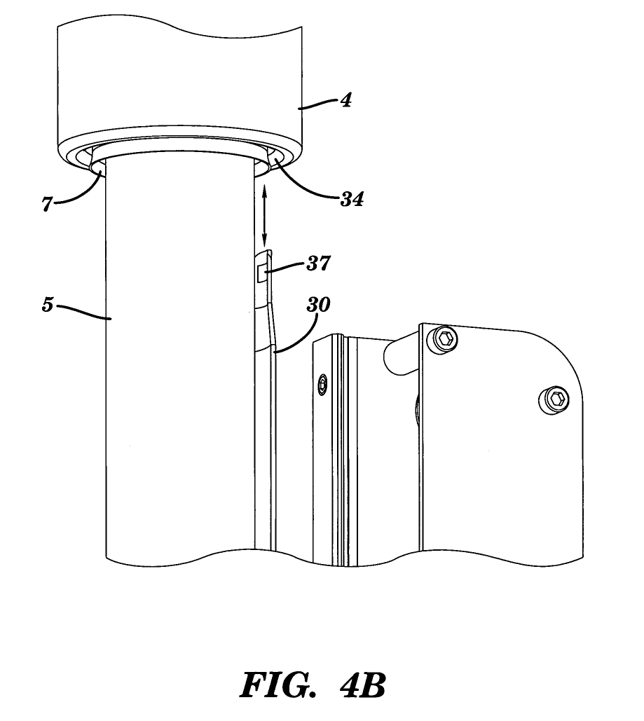

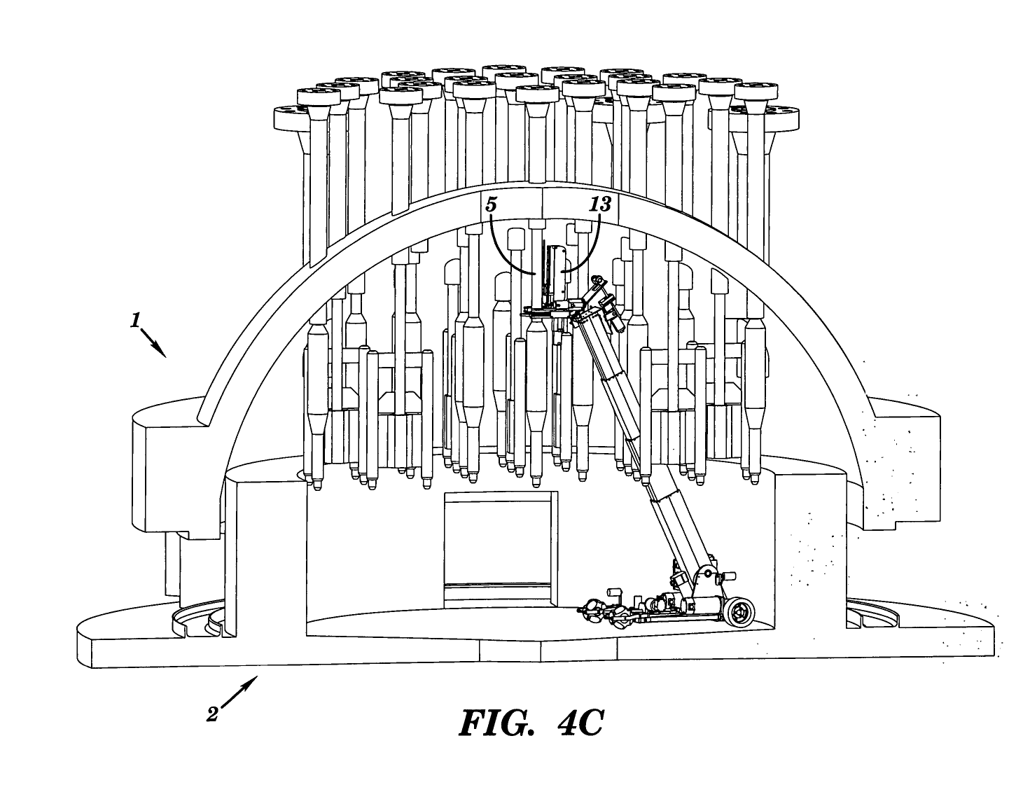

FIGS. 3B and 4A-4C show the sensing probe blade 30 in various stages of vertical insertion and removal into and out of the gap 34 between thermal sleeve 7 and the penetration component 4. After remotely controlled placement of the inspection probe 13 beneath a particular penetration component 4, the extendable boom is extended and guided, via the cameras 35 and movement controls circuitry (not shown), to a position adjacent a rack assembly 5 (FIGS. 3B, 4C). Then the sensing probe blade 30 is moved upwards into the gap 34. The sensing probe 37, mounted into the end of the probe blade 30, moves vertically into the gap 34 along the interior of the penetration component 4 for non-destructive inspection of the interior of the penetration component 4.

After inspection along a first vertical line portion of the penetration component 4, the probe blade 30 is withdrawn downward to a position removed from the gap 34 or a position directly adjacent the mouth of the gap 34. Thereafter, activation of motor 21 causes incremental rotational movement of the inspection probe 13, including the probe boom 26, around the vertical axis of the rack assembly 5 to be carried out to move the probe blade 30 to another circumferential location of the gap 34 in order to repeat the vertical elevation of the probe blade 30 into the gap 34 for inspecting another vertical line of the penetration component until a partial or complete 360° non-destructive inspection of the interior of the penetration component 4 is accomplished.

With the inspection system of the invention, the process of inspecting each penetration component and each in-core penetration component can be completed in turn without the need for assembling any vertical positioning and movement elements as is done in the prior art.

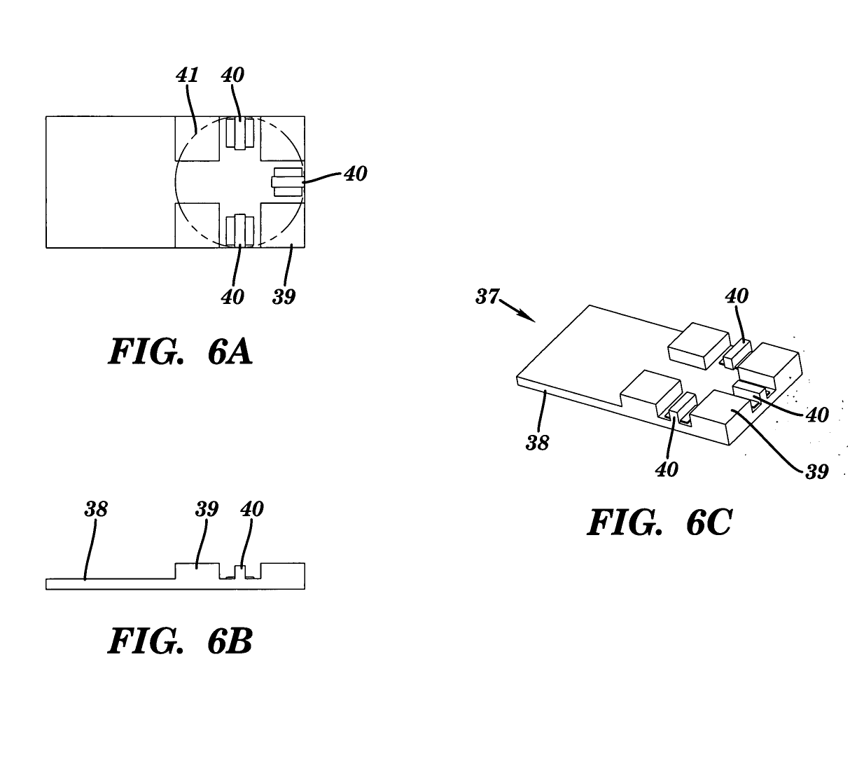

Turning to the sensing probe 37, FIGS. 6A-6C illustrate a preferred embodiment of the sensing probe for performing the non-destructive inspection of the interior of a penetration component 4. Specifically, the sensing probe 37 includes a printed circuit board 38 upon which are mounted raised sections 39 and magnetic field sensors 40 for circumferential and axial measurement of residual magnetic fields in the penetration components. Also included in the printed circuit board 38 is an eddy current sensor coil 41 for further non-destructive inspection of the penetration components.

Either of the sensors 40 or 41 can detect the presence of faults, i.e., cracks or fissures, in a penetration component utilizing the apparatus and method described above. However, the instant invention also includes the recognition that upon utilizing the magnetic field sensors to sense the residual magnetic field signatures over time in a penetration component, the likelihood of faults occurring at a particular location in the penetration component can be predicted. Such a process of utilizing magnetic field sensors to measure the residual magnetic field signatures over time enables repairs and replacement of components to be set out with much more predictability than all the prior art devices discussed above which only determine the presence of a fault after it has formed.

While the exact reason why the measurement of the magnetic field signatures over time enables the prediction of the location or locations for the formation of faults is not completely understood, the prediction of the location where a fault would likely occur appears to be based upon the change in residual magnetic field signature over time of a particular location on a penetration component in which the change is caused by the change in carbon content of the component at that particular location. This change in carbon content would appear to cause the formation of corrosive oxides at that particular location and therefore provide an indication of the potential for the formation of faults in that particular location. Upon gathering and compiling historical data for a particular component (or a series of components), the instantaneous magnetic field signature measurements for a particular location on a penetration component can be compared with that historical data or with an inventory or model of the historical changes in the residual magnetic field signatures of similar penetration components which have indicated an actual or probable location of defect and/or fault formation and, accordingly, the determination can then be made to repair or replace the penetration component immediately or at some other time in the future (prior to actual fault formation in the penetration component).

The method of determining the likelihood of the formation of defects and/or faults at a particular sensed location of a reactor head component would include the following steps:
performing the inspection of each component of the reactor head at predetermined time intervals and accumulating a library of residual magnetic field signatures for each sensed location of the component wherein the library includes the residual magnetic field signatures for sensed locations of components which have defects and/or faults at a sensed location and sensed locations of components which have no defects and/or faults at a sensed location,
comparing the residual magnetic field signatures for each sensed location from a most recent inspection to the library of residual magnetic field signatures of each sensed location to determine any change in the residual magnetic field signatures at each sensed location of component, and
determining the likelihood of the formation of a defect or fault at a particular sensed location of a component by a comparison of the most recent sensed residual magnetic field signature for a particular sensed location or a comparison of the change in residual magnetic field signature for a particular sensed location of the component with the library of residual magnetic field signatures for all components.

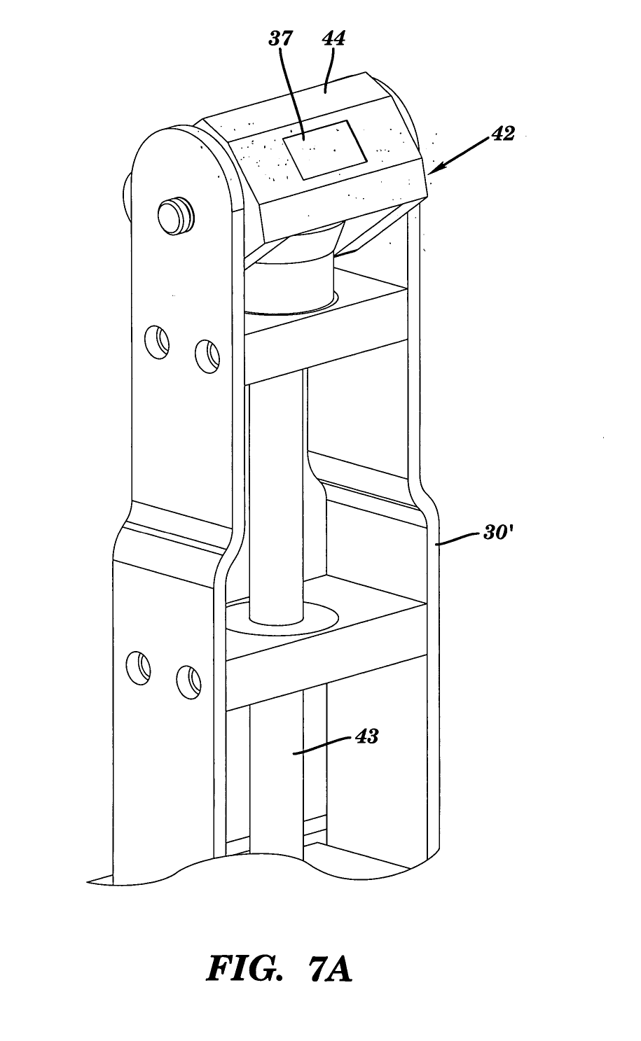

While the probe blade 30 has been shown for insertion into the gap 34 between the penetration component 4 and the thermal sleeve 7, the probe blade 30 and the probe blade support 32 can be removed from probe boom 26 and replaced with another design probe blade 30′ which can accomplish the non-destruction inspection of a J-weld 48 of the penetration component 4. Specifically, FIGS. 7A and 7B illustrate such a probe blade 30′ which includes a shaft slide 43 for the elevation of the probe blade 30′ and a blade head 42 which is shaped to complement the surface to be inspected, i.e., a curved or angled surface 44 which matches the surface of a J-weld 48.

Note also that in addition to inspection of the J-weld 48 area, the blade head 42 also be used to inspection the inner surface of the reactor head 3 in the area adjacent the J-weld by merely adjusting the angular position of the blade head 42 to present the sensing probe 37 to the inner surface of the reactor head 3. Similarly, by re-positioning the blade head 42 to present the sensing probe 37 to the exterior surface of the penetration component 4 and moving the blade head 42 in a vertical manner along the exterior surface of the penetration component 4 the non-destructive inspection of the interior of the penetration component can also be performed.

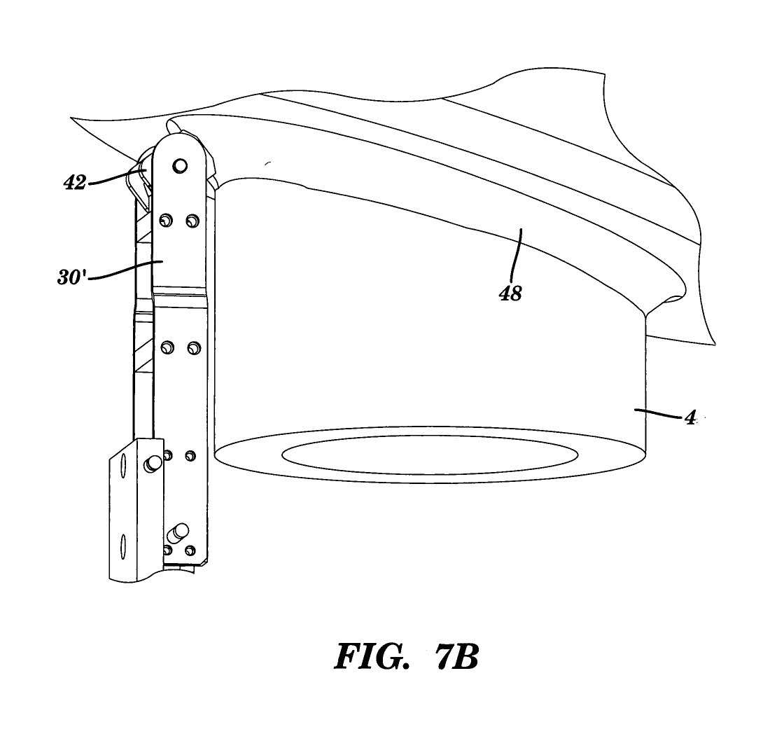

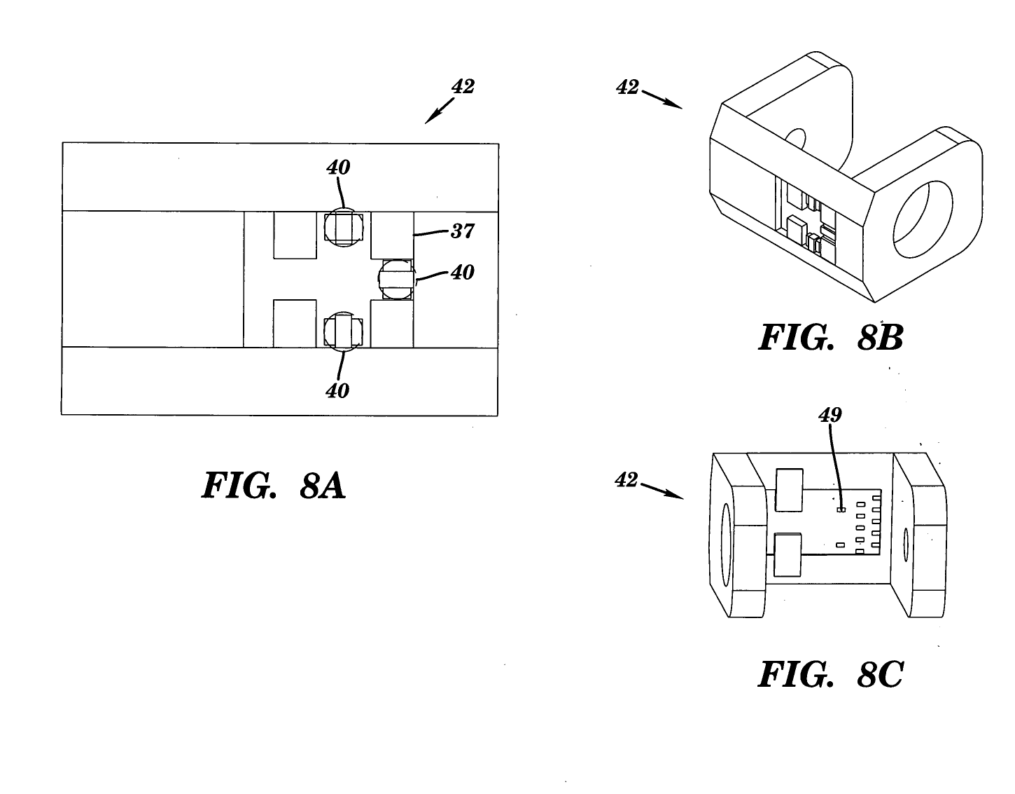

FIGS. 8A-8C show the sensing probe 37 of FIGS. 6A-6C mounted in the blade head 42 of the probe blade 30′. The details of the pad terminals 49 of the sensing probe 37 are also illustrated in FIG. 8C.

The non-destructive prediction of the likelihood of fault formation has been described with regard to the inspection of a penetration component of the interior of a reactor head; however, this technique and the sensor head of the invention can be utilized to inspect the components such as hydroelectric generation facilities, aircraft components and shipbuilding elements, i.e. welds, skin panels, motor casing, fluid conduits. For each use, the probe head would be re-designed to complement the object surface to be inspected which would enable the non-destructive inspection for the presence of faults and the prediction regarding the likelihood of the formation of faults at a particular location of the objects at some time in the future.

1. A reactor head inspection system for inspecting tubular components mounted on an interior surface of a reactor head comprising:
a movable carriage assembly including a elevation arm;
an inspection device mounted at a distal end of the elevation arm, the inspection device including,
an open-ended collar having an open end of sufficient dimension to enable positioning of an interior surface of the collar in close proximity to an exterior surface of a tubular component,
a plurality of video cameras for providing a positioning and an inspection view of the tubular component positioned adjacent the open end of the open-ended collar, at least one light source for projecting light positioned adjacent each video camera on the collar,
an inspection probe for non-destructively inspecting an interior and/or exterior surface of a tubular component; and
a positioning device mounted to the open-ended collar for manipulating the inspection probe,
wherein the positioning device and the open-ended collar are mounted on the elevation arm to enable positioning of the collar in close proximity adjacent a tubular component to achieve a 360° view of the exterior surface of the tubular component during positioning of the inspection device and during inspection of a tubular component, and
wherein the positioning device incrementally moves the inspection probe in a circular manner around a longitudinal axis of the tubular component and moves the inspection probe in a reciprocating vertical manner along the tubular component to perform a 360° inspection of the interior of the tubular component.

2. The reactor head inspection system of claim 1, wherein the open-ended collar is either C- or U-shaped.

3. The reactor head inspection system of claim 1, wherein the video cameras of the open-ended collar also provide non-destructive inspection the tubular component.

4. The reactor head inspection system of claim 1, wherein the non-destructive inspection device includes a sensing probe selected from the group consisting of a magnetic field sensor and an eddy-current sensor.

5. The reactor head inspection system of claim 1, wherein the light sources are light emitting diodes.

6. The reactor head inspection system of claim 1, wherein the elevation arm includes telescoping arm segments and the inspection device is mounted on a distal end of one of the arm segments.

7. The reactor head inspection system of claim 1, wherein the inspection probe is in the shape of an elongate blade having mounted at a distal end thereof a sensing probe selected from the group consisting of a magnetic field sensor and an eddy-current sensor.

8. The reactor head inspection system of claim 1, wherein the inspection probe is in the shape of an elongate blade having mounted at a distal end thereof a sensing probe which includes both a magnetic field sensor and an eddy-current sensor.

9. An inspection device for inspecting tubular components mounted on an interior surface of a reactor head comprising:
an inspection probe for non-destructively inspecting an interior surface of a tubular component including an open-ended collar having a distal surface and a proximal surface,
a plurality of video cameras providing a viewing field extending from the distal surface of the collar and providing a 360° view of an exterior surface of the tubular component,
a least one light source positioned adjacent each video camera for projecting light from the distal surface of the collar, and
a positioning device for manipulating the inspection probe,
wherein the positioning device and the open-ended collar cooperate to enable positioning of the collar in close proximity adjacent the tubular component to achieve a 360° view of the exterior surface of the tubular component in order to position the inspection device and to inspect the tubular component, and
wherein the positioning device incrementally moves the inspection probe in a circular manner around a longitudinal axis of the tubular component and moves the inspection probe in a reciprocating vertical manner to perform a 360° non-destructive inspection of the of the tubular component.

10. The inspection device of claim 9, wherein the open-ended collar is C- and U-shaped.

11. The inspection device of claim 9, wherein the video cameras of the open-ended collar also provide non-destructive inspection the tubular component.

12. The inspection device of claim 9, wherein the light sources are light emitting diodes.

13. The inspection device of claim 9, wherein the non-destructive inspection device includes a sensing probe selected from the group consisting of a magnetic field sensor and an eddy-current sensor.

14. The inspection device of claim 9, wherein the inspection probe is in the shape of an elongate blade having mounted at a distal end thereof a sensing probe selected from the group consisting of a magnetic field sensor and an eddy-current sensor.

15. The inspection device of claim 9, wherein the inspection probe is in the shape of an elongate blade having mounted at a distal end thereof a sensing probe which includes both a magnetic field sensor and an eddy-current sensor.

16. The reactor head inspection system of claim 1, wherein the inspection probe includes an inspection head having an arcuate or angled exterior surface complementary to the shape of a J-weld and having mounted therein a sensing probe selected from the group consisting of a magnetic field sensor and an eddy-current sensor.

17. The reactor head inspection system of claim 1, wherein the inspection probe includes an inspection head having an arcuate or angled exterior surface complementary to the shape of a J-weld and having mounted therein a sensing probe which includes both a magnetic field sensor and an eddy-current sensor.

18. The inspection device of claim 9, wherein the inspection probe includes an inspection head having an arcuate or angled exterior surface complementary to the shape of a J-weld and having mounted therein a sensing probe selected from the group consisting of a magnetic field sensor and an eddy-current sensor.

19. The inspection device of claim 9, wherein the inspection probe includes an inspection head having an arcuate or angled exterior surface complementary to the shape of a J-weld and having mounted therein a sensing probe which includes both a magnetic field sensor and an eddy-current sensor.

20. A method of inspecting components mounted on an interior surface of a reactor head comprising the steps of:
placing a reactor head on a support stand having an access port providing access for an inspection system beneath the reactor head;
moving an inspection system through the access port to a position beneath the reactor head, the inspection system comprising:
a movable carriage assembly including a elevation arm;
an inspection device mounted at a distal end of the elevation arm, the inspection device including,
an open-ended collar having an open end of sufficient dimension to enable positioning of the interior surface of the collar in close proximity to an exterior surface of a tubular component,
a plurality of video cameras for providing a positioning and an inspection view of the tubular component positioned adjacent the open end of the open-ended collar,
at least one light source for projecting light positioned adjacent each video camera on the collar,
an inspection probe for non-destructively inspecting an interior and/or exterior surface of a tubular component; and
a positioning device mounted to the open-ended collar for manipulating the inspection probe,
extending the elevation arm into the vicinity of a component mounted on the interior of the reactor head;
positioning the inspection device adjacent to the component, utilizing the video cameras and light sources for guidance, such that the positioning device and the open-ended collar are positioned in close proximity to the component to achieve a 360° view of a surface of the component during inspection of the component;
incrementally moving the inspection probe around an axis of the component and moving the inspection probe in a reciprocating manner along the component; and
performing a non-destructive inspection of the component utilizing the inspection probe during each movement of the inspection probe along the component to determine the presence of defects and/or faults at a particular sensed location in the component,
wherein upon completion of the incremental movement of the inspection probe around the axis of the component a 360° non-destructive inspection of the component is achieved.

21. The method of inspecting components of claim 20, wherein the components are tubular components mounted vertically within the reactor head and the incremental movement of the inspection probe is around a longitudinal axis of a tubular component and the reciprocating movement of the inspection probe is along the vertical extent of the tubular component.

22. The method of inspecting components of claim 21, wherein the inspection probe is incrementally moved around an interior surface of the tubular component.

23. The method of inspecting components of claim 21, wherein the inspection probe is incrementally moved around an exterior surface of the tubular component.

24. The method of inspecting components of claim 21, wherein the tubular component is welded to the interior reactor head and the incremental and vertical movement inspection probe positions the inspection probe adjacent the weld to perform a 360° non-destructive inspection of the weld.

25. The method of inspecting components of claim 20, wherein the inspection probe includes, at a distal end thereof, a sensing probe selected from the group consisting of a magnetic field sensor and an eddy-current sensor, and the incremental and reciprocating movement moves the distal end of the elongate blade around and along the component such that the sensing probe senses either a residual magnetic field or an electric field at each sensed location of the component.

26. The method of inspecting components of claim 20, wherein the inspection probe includes, at a distal end thereof, a sensing probe which includes both a magnetic field sensor and an eddy-current sensor, and the incremental and reciprocating movement moves the distal end of the elongate blade around and along the component. such that the sensing probe senses both a residual magnetic field and an electric field at each sensed location of the component.

27. The method of inspecting components of claim 20, wherein the inspection probe is in the shape of an elongate blade having mounted at a distal end thereof a sensing probe selected from the group consisting of a magnetic field sensor and an eddy-current sensor, and the incremental and reciprocating movement moves the distal end of the elongate blade around and along the component such that the sensing probe senses either a residual magnetic field or an electric field at each sensed location of the component.

28. The method of inspecting components of claim 20, wherein the inspection probe is in the shape of an elongate blade having mounted at a distal end thereof a sensing probe which includes both a magnetic field sensor and an eddy-current sensor, and the incremental and reciprocating movement moves the distal end of the elongate blade around and along the component. such that the sensing probe senses both a residual magnetic field and an electric field at each sensed location of the component.

29. The method of inspecting components of claim 24, wherein the inspection probe includes an inspection head having an arcuate or angled exterior surface complementary to the shape of the weld and having mounted therein a sensing probe selected from the group consisting of a magnetic field sensor and an eddy-current sensor, and the incremental and reciprocating movement moves the inspection head around and along the weld such that the sensing probe senses either a residual magnetic field or an electric field at each sensed location of the weld and/or in the adjacent vicinity of the reactor head.

30. The method of inspecting components of claim 24, wherein the inspection probe includes an inspection head having an arcuate or angled exterior surface complementary to the shape of the weld and having mounted therein a sensing probe which includes both a magnetic field sensor and an eddy-current sensor, and the incremental and reciprocating movement moves the inspection head around and along the weld such that the sensing probe senses both a residual magnetic field and an electric field at each sensed location of the weld and/or in the adjacent vicinity of the reactor head.

31. The method of inspecting components of claim 20, wherein the inspection probe includes a magnetic field sensor, and the incremental and reciprocating movement moves the magnetic field sensor to sense a residual magnetic field signature at each sensed location of the component, and the method further comprises
performing the inspection of each component of the reactor head at predetermined time intervals and accumulating a library of residual magnetic field signatures for each sensed location of the component wherein the library includes the residual magnetic field signatures for sensed locations of components which have defects and/or faults at a sensed location and sensed locations of components which have no defects and/or faults at a sensed location,
comparing the residual magnetic field signatures for each sensed location from a most recent inspection to the library of residual magnetic field signatures of each sensed location to determine any change in the residual magnetic field signatures at each sensed location of component, and
determining the likelihood of the formation of a defect or fault at a sensed location of a component by a comparison of the most recent sensed residual magnetic field signature for a particular sensed location or a comparison of the change in residual magnetic field signature for a particular sensed location of the component with the library of residual magnetic field signatures for all components.

32. A method of inspecting components mounted on an interior surface of a reactor head comprising the steps of:
incrementally moving an inspection probe around an axis of the component and moving the inspection probe in a reciprocating manner along the component; and
performing a non-destructive inspection of the component utilizing the inspection probe during each movement of the inspection probe along the component to determine the presence of defects and/or faults at a particular sensed location in the component,
wherein upon completion of the incremental movement of the inspection probe around the axis of the component a 360° non-destructive inspection of the component is achieved, and
wherein the inspection probe includes a magnetic field sensor, and the incremental and reciprocating movement moves the magnetic field sensor to sense a residual magnetic field signature at each sensed location of the component, the method further comprising the steps of:
performing the inspection of each component of the reactor head at predetermined time intervals and accumulating a library of residual magnetic field signatures for each sensed location of the component wherein the library includes the residual magnetic field signatures for sensed locations of components which have defects and/or faults at a sensed location and the residual magnetic field signatures for sensed locations of components which have no defects and/or faults at a sensed location,
comparing the residual magnetic field signatures for each sensed location from a most recent inspection to the library of residual magnetic field signatures of each sensed location to determine any change in the residual magnetic field signatures at each sensed location of component, and
determining the likelihood of the formation of a defect or fault at a sensed location of a component by a comparison of the most recent sensed residual magnetic field signature for a particular sensed location or a comparison of the change in residual magnetic field signature for a particular sensed location of the component with the library of residual magnetic field signatures for all components.

33. A method of inspecting components comprising the steps of:
incrementally moving an inspection probe around an axis of a component and moving the inspection probe in a reciprocating manner along the component; and
performing a non-destructive inspection of the component utilizing the inspection probe during each movement of the inspection probe along the component to determine the presence of defects and/or faults at a particular sensed location in the component,
wherein upon completion of the incremental movement of the inspection probe around the axis of the component a 360° non-destructive inspection of the component is achieved, and
wherein the inspection probe includes a magnetic field sensor, and the incremental and reciprocating movement moves the magnetic field sensor to sense a residual magnetic field signature at each sensed location of the component, the method further comprising the steps of:
performing the inspection of each component at predetermined time intervals and accumulating a library of residual magnetic field signatures for each sensed location of the component wherein the library includes the residual magnetic field signatures for sensed locations of components which have defects and/or faults at a sensed location and the residual magnetic field signatures for sensed locations of components which have no defects and/or faults at a sensed location,
comparing the residual magnetic field signatures for each sensed location from a most recent inspection to the library of residual magnetic field signatures of each sensed location to determine any change in the residual magnetic field signatures at each sensed location of component, and
determining the likelihood of the formation of a defect and/or fault at a sensed location of a component by a comparison of the most recent sensed residual magnetic field signature for a particular sensed location or a comparison of the change in residual magnetic field signature for a particular sensed location of the component with the library of residual magnetic field signatures for all components.

34. A method of inspecting components comprising the steps of:
moving a non-destructive inspection probe along a component; and
performing a non-destructive inspection of the component utilizing the inspection probe during each movement of the inspection probe along the component to determine the presence of defects and/or faults at a particular sensed location in the component,
wherein the inspection probe includes a magnetic field sensor, and the movement moves the magnetic field sensor to sense a residual magnetic field signature at each sensed location of the component, the method further comprising the steps of:
performing the inspection of each component at predetermined time intervals and accumulating a library of residual magnetic field signatures for each sensed location of the component wherein the library includes the residual magnetic field signatures for sensed locations of components which have defects and/or faults at a sensed location and the residual magnetic field signatures for sensed locations of components which have no defects and/or faults at a sensed location,
comparing the residual magnetic field signatures for each sensed location of a component from a most recent inspection to the library of residual magnetic field signatures of each sensed location to determine any change in the residual magnetic field signatures at each sensed location of component, and
determining the likelihood of the formation of a defect and/or fault at a sensed location of a component by a comparison of the most recent sensed residual magnetic field signature for a particular sensed location or a comparison of the change in residual magnetic field signature for a particular sensed location of the component with the library of residual magnetic field signatures for all components.
